(19) United States
(12) Patent Application Publication
(10) Pub. No.: US 2017/0341560 A1
(43) Pub. Date: Nov. 30, 2017

(54) TAILGATE LOADING RAMP

(71) Applicant: FORD GLOBAL TECHNOLOGIES, LLC, Dearborn, MI (US)

(72) Inventors: Dragan B. STOJKOVIC, Taylor, MI (US); Jack MARCHLEWSKI, Saline, MI (US); Joshua R. HEMPHILL, White Lake, MI (US)

(21) Appl. No.: 15/168,647

(22) Filed: May 31, 2016

(51) Int. Cl. B60P 1/43; B65G 67/02

(52) U.S. Cl. CPC B60P 1/435; B65G 67/02

(57) ABSTRACT

A loading ramp for a tailgate is stored and transported on the inside wall of the tailgate. The loading ramp includes a base section pivotally connected to an inner wall of the tailgate. A ramp section is connected to the base section by a hinge and is movable between a loading position extending from a distal edge of the tailgate to a ground surface and a transport position folded against the base section in a transverse/vertical plane. An alternative loading ramp includes a top section, a top hinge connecting the top section to a distal edge of the tailgate, a bottom section, and an intermediate hinge connecting the bottom section to the top section. The top section and the bottom section are stored with the top section and bottom section parallel to each other and to the tailgate.

### TECHNICAL FIELD

This disclosure relates to loading ramps assembled to a pick-up truck tailgate that are used to facilitate loading and unloading cargo.

### BACKGROUND

Loading ramps are used to load and unload cargo to be transported in a pick-up truck bed. Loading ramps may be loosely stored in a pick-up truck bed and attached by hooks, clamps or fasteners to the rear edge of the tailgate when the tailgate is lowered to in open, or horizontal, position. Loading ramps that are transported in the pick-up truck bed reduce available space for other cargo and are cumbersome to install and remove. Loading ramps transported in the pick-up truck bed should be secured to the truck during transportation to prevent them from sliding around the pick-up truck bed.

Alternatively, a loading ramp may be stored inside a sidewall or tailgate to secure the loading ramp during transportation and then assembled to the tailgate in the open position. Storing loading ramps inside a sidewall or inside the tail gate reduces the space required to store the loading ramps. However, the problems relating to assembling the loading ramps to the tailgate and disassembling the loading ramps are increased.

This disclosure is directed to solving the above problems and other problems as summarized below.

### SUMMARY

According to one aspect of this disclosure, a loading ramp is provided that is stored on an inside wall of the tailgate. The loading ramp includes a base section pivotally connected to an inner wall of the tailgate. The loading ramp and tailgate pivot between a transverse/vertical plane and a longitudinal/horizontal plane. A ramp section is connected to the base section by a hinge and is movable between a loading position extending from a distal edge of the tailgate to a ground surface and a transport position folded against the base section in the transverse/vertical plane.

According to other aspects of this disclosure, the loading ramp may further comprise a second base section pivotally connected to an inner wall of the tailgate to pivot between a transverse/vertical plane and a longitudinal/horizontal plane, and a second ramp section connected to the second base section by a second hinge. The second ramp section is movable between a second loading position extending from a distal edge of the tailgate to the ground surface and a second transport position folded against the base section in the transverse/vertical plane.

The base section may be connected to the inner wall of the tailgate at a first location, and the second base section may be connected to the inner wall of the tailgate at a second location laterally and longitudinally spaced from the first location. The first location and second location may be vertically offset by at least a width of the loading ramp when the tailgate is closed.

The loading ramp may further comprise a latch securing the ramp section to the base section when the ramp is in the transport position, and a second latch securing the second ramp section to the second base section when the second ramp is in the transport position.

The hinge may be disposed between a first pivot connection that connects the base section and the tailgate and a first lateral edge of the tailgate that is closest to the first pivot connection. The second hinge may be disposed between a second pivot connection that connects the second base section and the tailgate and a second lateral edge of the tailgate that is closest to the second pivot connection.

The loading ramp may further comprise a pivot pin provided on the base section and a first plurality of receptacles provided on the inner surface of the tailgate. Each of the first plurality of receptacles are transversely spaced apart from others of the first plurality of receptacles. The pivot pin is insertable into one of the plurality of receptacles to locate the ramp at a selected lateral portion on the tailgate. A second pivot pin may be provided on the second base section and a second plurality of receptacles may be provided on the inner surface of the tailgate. Each of the second plurality of receptacles are transversely spaced apart from others of the second plurality of receptacles. The second pivot pin is insertable into one of the second plurality of receptacles to locate the second ramp at a selected lateral location.

The loading ramp may further comprise a latch securing the ramp section relative to the base section when the ramp is in the transport position.

The hinge may be disposed between a pivot connection that connects the base section and the tailgate and a lateral edge of the tailgate that is closest to the pivot connection.

The loading ramp may further comprise a pivot pin, and a plurality of receptacles assembled to the inner surface of the tailgate with each of the receptacles being transversely spaced apart from other receptacles, wherein the pivot pin is insertable into one of the plurality of receptacles to locate the ramp laterally on the tailgate.

According to another aspect of this disclosure, a loading ramp is provided for a pick-up truck having a tailgate. The loading ramp includes a first loading ramp pivotally connected at a first location to an inner wall of the tailgate. The first loading ramp has a first ramp section extendable from the distal edge of the tailgate to a ground surface and a first pivoting section extending from the first location to the distal edge. A first hinge connects the first ramp section to the first pivoting section. In addition, a second loading ramp is pivotally connected at a second location to an inner wall of the tailgate laterally and longitudinally spaced from the first location. The second loading ramp has a second ramp section extendable from the distal edge of the tailgate to the ground surface and a second pivoting section extending from the second location to the distal edge. A second hinge connects the second ramp section to the second pivoting section.

According to another aspect of this disclosure, a loading ramp is provided that is attached to a pick-up truck tailgate. The loading ramp comprises a top section, a top hinge connecting the top section to a distal edge of the tail gate, a bottom section, and an intermediate hinge connecting the bottom section to the top section, wherein the top section and the bottom section are stored with the top section and bottom section parallel to each other and to the tailgate. The top section and the bottom section are pivoted to form a ramp extending in a common plane from the distal edge of the tailgate to a ground surface.

The above aspects of this disclosure and other aspects are described below with reference to the attached drawings.

### BRIEF DESCRIPTION OF THE DRAWINGS

FIG. 1 is a right/rear perspective view of a pick-up truck with its tailgate open and two ramps disposed in a loading position.

FIG. 2 is a right/rear perspective view of a pick-up truck with its tailgate open and two ramps pivoted upwardly to a position between the loading position and a transport position.

FIG. 3 is a right/rear perspective view of a pick-up truck with its tailgate open and two ramps in the transport position.

FIG. 4 is a right/rear perspective view of a pick-up truck with its tailgate open and two ramps made according to an alternative embodiment in which the two ramps may be attached to the tailgate at different lateral locations disposed in a loading position.

FIG. 5 is a right/rear perspective view of a pick-up truck with its tailgate open made according to an alternative embodiment in which the ramp extends across the full width of the tailgate disposed in a loading position.

FIG. 6 is a fragmentary perspective view of the embodiment of FIG. 5 showing a pivot connector connecting an upper ramp section to a lower ramp section.

FIG. 7 is a diagrammatic partial cross-section view of the embodiment of FIG. 5 in an intermediate stage with the ramp sections stacked on the tailgate.

FIG. 8 is a diagrammatic partial cross-section view of the embodiment of FIG. 5 in a stowed, or transport position, with the ramp sections folded against an inner wall of the tailgate.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Referring to FIG. 1, a pick-up truck 10 is illustrated that includes a bed 12 and a tailgate 14. The tailgate 14 is shown in its open position in FIG. 1. A right ramp 16 and left ramp 18 are attached to an inner wall 20 of the tailgate 14. Ramp 16 includes a base section 24 and a ramp section 26 connected by a pivot connector 28, or hinge. The ramp 18 includes a base section 30 and a ramp section 32 connected by a pivot connector 34. Base section 24 is pivotally connected to the inner wall 20 of the tailgate 14 by a pivot pin 36. Base section 30 is pivotally connected to the inner wall 20 of the tailgate 14 by a pivot pin 38. The base sections 24 and 30 are disposed in a transverse/horizontal plane in a loading position. The ramp sections 26 and 32 extend downwardly from a distal end 40 of the tailgate 14 to the ground 42. The pivot pin 36 is assembled to the tailgate 14 at a first location that is laterally and longitudinally spaced from a second location where the pivot pin 38 is assembled to the tailgate 14.

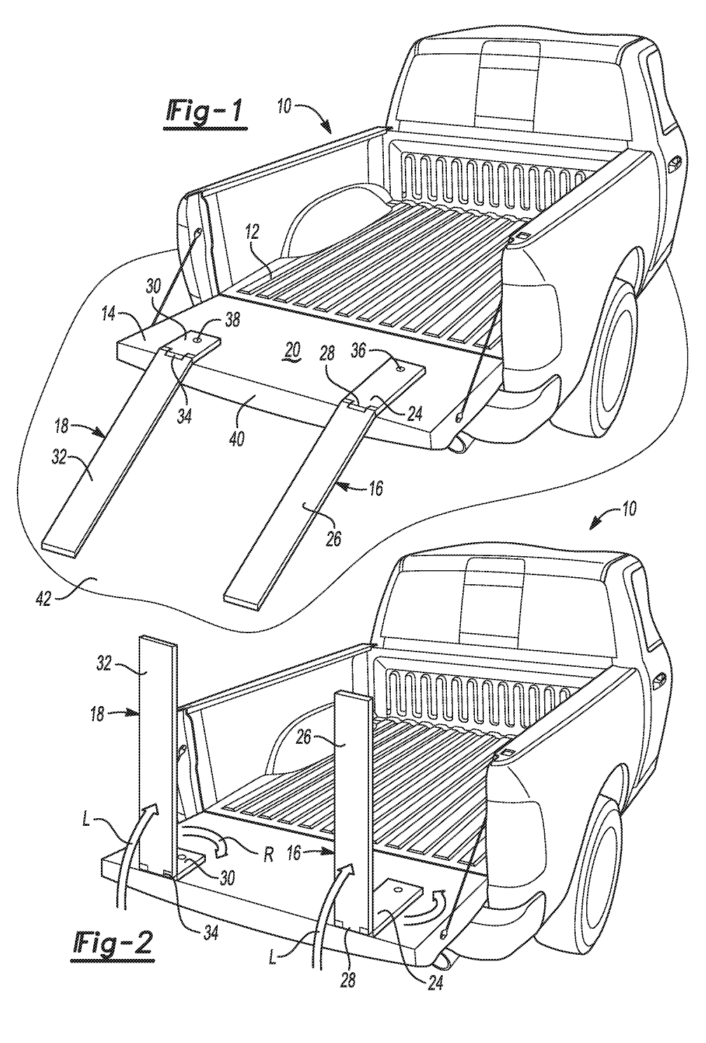

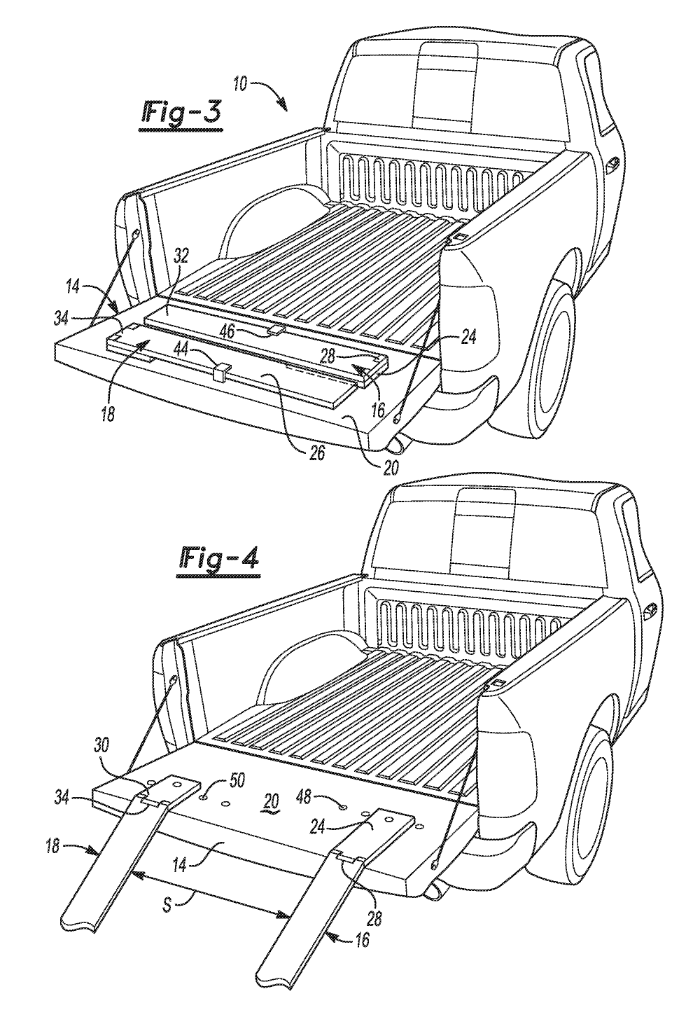

Referring to FIG. 2, the pick-up truck 10 is illustrated with the right ramp 16 and the left ramp 18 shown in an intermediate position with the ramp sections 26 and 32 pivoted to a vertical orientation. The arrows “L” indicate movement of the ramp sections 26 and 32 from the loading position shown in FIG. 1 toward a transport position that will be described below with reference to FIG. 3. The arrows “R” indicate the pivoting movement of the base sections 24 and 30 as they are moved to the transport position.

Referring to FIG. 3, the pick-up truck 10 is illustrated with the right ramp 16 and the left ramp 18 shown in the transport position. In the transport position the ramp sections 26 and 32 are folded over the base sections 24 and 30, respectively, and parallel to each other. Latches 44 and 46 may be provided on the inner wall 20 of the tailgate 14 to secure the ramps 16 and 18 in the transport position on the tailgate 14. The ramp sections 16 and 18 are disposed in a transverse/vertical plane in the transport position with the right ramp section 16 below the left ramp 18 as shown, but the relative location of the ramps may be reversed.

Referring to FIG. 4, an alternative embodiment is illustrated that accommodates loading and unloading cargo having wheels that are laterally spaced apart to a greater or lesser extent into the bed. Base section 24 is attached to a first plurality of receptacles 48 on the right side of the inner wall 20 that are laterally spaced from each other as indicated by the arrow “S”. Base section 30 is attached to a second plurality of laterally spaced receptacles 50 on the left side of the inner wall 20. The first set of receptacles 48 is located further from the distal end of the tailgate 14 than the second set of receptacles 50. The receptacles 48 are vertically offset from receptacles 50 when the tailgate 14 is closed and in the transverse/vertical plane to arrange the right ramp 16 below the left ramp 18 when the tailgate 14 is closed in the transport position.

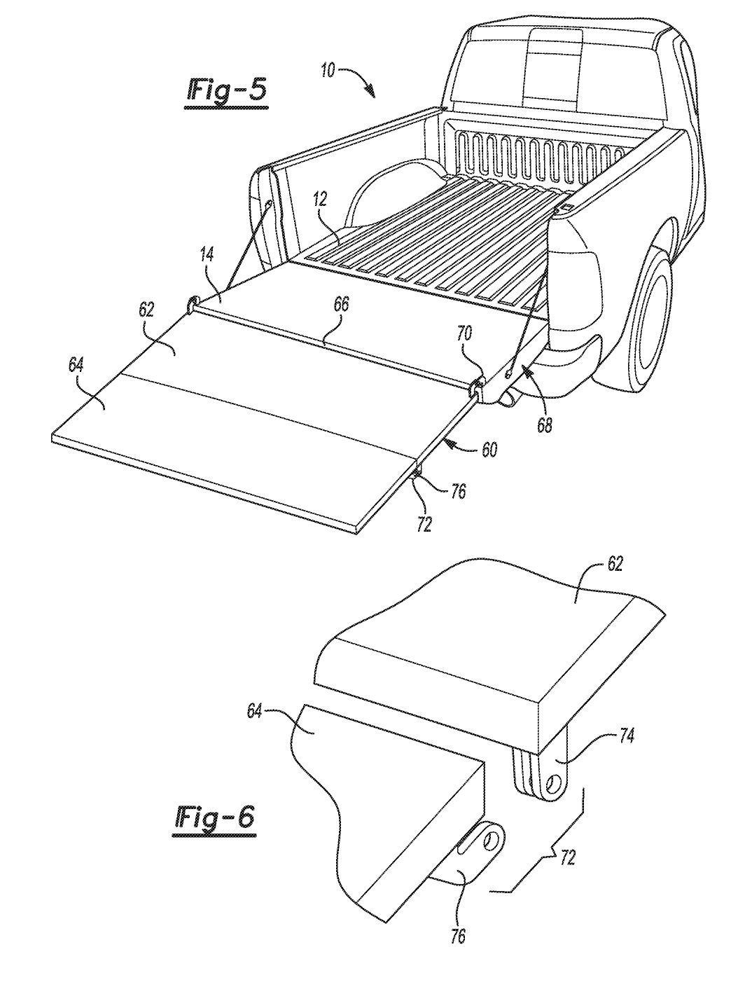

Referring to FIG. 5, another alternative embodiment is illustrated that includes a full-width ramp 60. The ramp 60 includes a top section 62 and a bottom section 64. The top section 62 is attached to the distal end 66 of the tailgate 68 by a top hinge 70. The top section 62 and bottom section 64 are connected by an intermediate hinge 72.

Referring to FIG. 6, the intermediate hinge 72 is shown separated from each other. A first part 74 of the intermediate hinge 72 is provided on the top section 62 and a second part 76 of the intermediate hinge 72 is provided on the bottom section 64. A pin 78 (shown in FIG. 5) is not shown in FIG. 6, but is used to connect the first part 74 to the second part 76. As shown in FIG. 5, the top section 62 and lower section 64 pivot on the intermediate hinge 72 until they engage each other and are held in the same plane to form a continuous ramp surface.

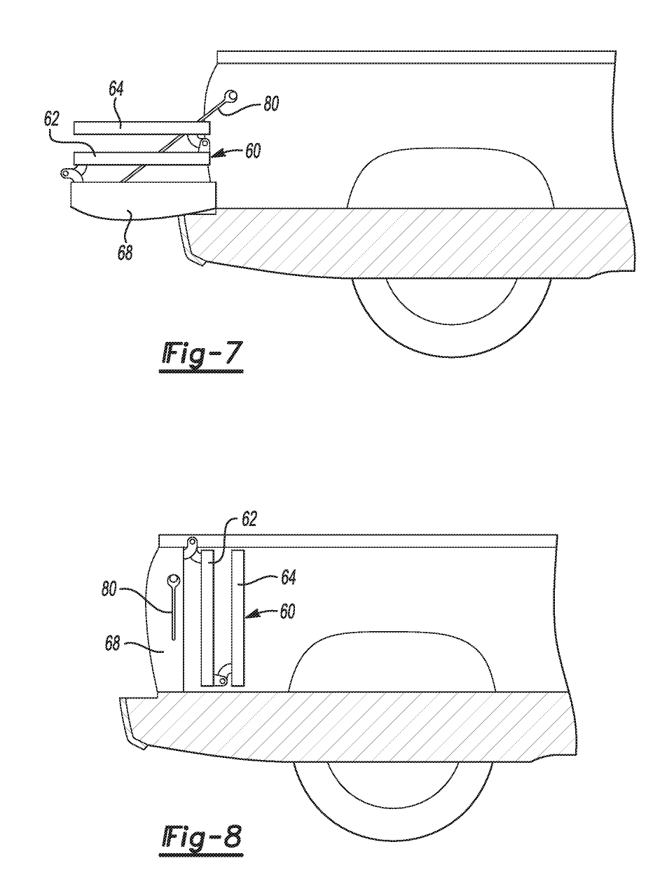

Referring to FIG. 7, the bottom section 64 of the ramp 60 is shown folded over the top section 62 and the tailgate 68. The spacing between the tailgate 68, top section 62 and bottom section 64 as shown in FIGS. 7 and 8 as shown is enlarged for better visibility and may be decreased to reduce the space required for storage of the ramp 60. The tail gate is held by a cable 80 when open to limit movement of the tailgate 68 to a lateral/horizontal orientation.

Referring to FIG. 8, the ramp 60 is shown in the transport position with the top section 62 and the bottom section 64 stored parallel to each other and parallel to the tailgate 68.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. A loading ramp for a tailgate, comprising:
a base section pivotally connected to an inner wall of the tailgate that pivots between a transverse/vertical plane and a longitudinal/horizontal plane; and
a ramp section connected to the base section by a hinge, the ramp section being movable between—
a deployed position extending from a distal edge of the tailgate to a ground surface, and
a transport position folded against the base section in the transverse/vertical plane.

2. The loading ramp of claim 1 further comprising:
a second base section pivotally connected to an inner wall of the tailgate that pivot a transverse/vertical plane and a longitudinal/horizontal plane; and
a second ramp section connected to the second base section by a second hinge, the second ramp section being movable between—
a second deployed position extending from a distal edge of the tailgate to the ground surface, and
a second transport position folded against the base section in the transverse/vertical plane.

3. The loading ramp of claim 2 wherein the base section is connected to the inner wall of the tailgate at a first location, and the second base section is connected to the inner wall of the tailgate at a second location laterally and longitudinally spaced from the first location.

4. The loading ramp of claim 3 wherein the first location and second location are vertically offset by at least a width of the loading ramp when the tailgate is in a closed position.

5. The loading ramp of claim 2 further comprising:
a latch securing the ramp section to the base section when the ramp is in the transport position; and
a second latch securing the second ramp section to the second base section when the second ramp is in the transport position.

6. The loading ramp of claim 2 wherein the hinge is disposed between a first pivot connection between the base section and the tailgate and a first lateral edge of the tailgate that is closest to the first pivot connection, and wherein the second hinge is disposed between a second pivot connection between the second base section and the tailgate and a second lateral edge of the tailgate that is closest to the second pivot connection.

7. The loading ramp of claim 2 further comprising:
a pivot pin provided on the base section;
a first plurality of receptacles assembled to the inner surface of the tailgate with each of the first plurality of receptacles being transversely spaced apart from the others of the first plurality of receptacles, wherein the pivot pin is insertable into one of the plurality of receptacles;
a second pivot pin provided on the second base section; and
a second plurality of receptacles assembled to the inner surface of the tailgate with each of the second plurality of receptacles being transversely spaced apart from the others of the second plurality of receptacles, wherein the second pivot pin is insertable into one of the second plurality of receptacles.

8. The loading ramp of claim 1 further comprising:
a latch securing the ramp section to the base section when the ramp is in the transport position.

9. The loading ramp of claim 1 wherein the hinge is disposed between a pivot connection between the base section and the tailgate and a lateral edge of the tailgate that is closest to the pivot connection.

10. The loading ramp of claim 1 further comprising:
a pivot pin; and
a plurality of receptacles assembled to the inner surface of the tailgate with each of the receptacles being transversely spaced apart from the other receptacles, wherein the pivot pin is insertable into one of the plurality of receptacles.

11. A loading ramp for a pick-up truck that has a tailgate, comprising:
a first loading ramp pivotally connected to an inner wall of the tailgate at a first location, the first loading ramp having a first ramp section extendable from the distal edge of the tailgate to a ground surface and a first pivoting section extending from the first location to the distal edge, and a first hinge connecting the first ramp section to the first pivoting section;
a second loading ramp pivotally connected to an inner wall of the tailgate at a second location laterally and longitudinally spaced from the first location, the second loading ramp having a second ramp section extendable from the distal edge of the tailgate to the ground surface and a second pivoting section extending from the second location to the distal edge, and second hinge connecting the second ramp section to the second pivoting section.

12. The loading ramp of claim 11 wherein the base section is connected to the inner wall of the tailgate at a first location, and the second base section is connected to the inner wall of the tailgate at a second location laterally and longitudinally spaced from the first location.

13. The loading ramp of claim 11 wherein the first location and second location are vertically offset by at least a width of the loading ramp when the tailgate is in a closed position.

14. The loading ramp of claim 11 further comprising:
a latch securing the ramp section to the base section when the ramp is in the transport position; and
a second latch securing the second ramp section to the second base section when the second ramp is in the transport position.

15. The loading ramp of claim 11 wherein the hinge is disposed between a first pivot connection between the base section and the tailgate and a first lateral edge of the tailgate that is closest to the first pivot connection, and wherein the 1 wherein the second hinge is disposed between a second pivot connection between the second base section and the tailgate and a second lateral edge of the tailgate that is closest to the second pivot connection.

16. The loading ramp of claim 11 further comprising:
a pivot pin provided on the base section;
a first plurality of receptacles assembled to the inner surface of the tailgate with each of the first plurality of receptacles being transversely spaced apart from the others of the first plurality of receptacles, wherein the pivot pin is insertable into one of the plurality of receptacles;
a second pivot pin provided on the second base section; and
a second plurality of receptacles assembled to the inner surface of the tailgate with each of the second plurality of receptacles being transversely spaced apart from the others of the second plurality of receptacles, wherein the second pivot pin is insertable into one of the second plurality of receptacles.

17. A loading ramp attached to a pick-up truck tailgate comprising:
a top section;
a top hinge connecting the top section to a distal edge of the tailgate;
a bottom section;
an intermediate hinge connecting the bottom section to the top section, wherein the top section and the bottom section are stored with the top section and bottom section parallel to each other and to the tailgate, and wherein the top section and the bottom section are pivoted to form a ramp extending in a common plane from the distal edge of the tailgate to a ground surface.

18. The loading ramp of claim 17 wherein the top section pivots from a storage position parallel to the tailgate to a loading position, wherein the hinge and distal edge of the tailgate stop further pivoting.

19. The loading ramp of claim 17 wherein the bottom section pivots from a storage position parallel to the top section and the tailgate to a loading position, wherein the intermediate hinge and an adjacent edge of the top section stop further pivoting of the bottom section.

20. The loading ramp of claim 17 wherein the top section pivots in one rotary direction about the top hinge and the bottom section pivots in a second rotary direction about the intermediate hinge, wherein the second rotary direction is opposite the first rotary direction.
